(19) United States
(12) Patent Application Publication
(10) Pub. No.: US 2010/0079474 A1
(43) Pub. Date: Apr. 1, 2010

(54) METHODS FOR RENDERING SOURCE CONTENT OF A FILE FOR DISPLAY ON A DESTINATION FIGURE

(75) Inventors: Ambarish Sridharanarayanan, Redmond, WA (US); Georgi M. Chalakov, Duvall, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/241,938

(22) Filed: Sep. 30, 2008

(51) Int. Cl. G09G 5/36

(52) U.S. Cl. 345/553

(57) ABSTRACT

A method for rendering source content of a file for display in a destination figure is provided. The method may include receiving the source content of the file including a brush that defines a viewbox having a first coordinate system, composing a viewport having a second coordinate system to which a brush transform is applied, creating an empty destination bitmap sized according to a destination figure transform, and rendering the source content onto the empty destination bitmap such that the first coordinate system is transformed into the second coordinate system.

### BACKGROUND

A fixed-document file preserves document fidelity and appearance regardless of the type of device on which the document is presented. In order to preserve the fidelity of a document, a fixed-document file includes markup language or objects that define the layout and visual appearance of each page of the document as well as rules that describe the processing, rendering, and printing intent of the document. The manner in which these rules are implemented may allow for great flexibility in the manner in which a document is rendered to accommodate differences in functionality of different rendering engines. However, differences in rendering engines may cause some rendering engines to render a fixed document file with sub-optimal rendering fidelity, rendering time, memory usage, and/or output file size. This may result in decreased quality of output, resulting in decreased user satisfaction.

### SUMMARY

A method for rendering source content of a file for display in a destination figure is provided. The method may include receiving the source content of the file including a brush that defines a viewbox having a first coordinate system, composing a viewport having a second coordinate system to which a brush transform is applied, creating an empty destination bitmap sized according to a destination figure transform, and rendering the source content onto the empty destination bitmap such that the first coordinate system is transformed into the second coordinate system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an architecture diagram of an embodiment of a file rendering system.

FIG. 2 is a flow diagram of an embodiment of a method for rendering source content of a file for display on a destination figure.

FIG. 3 is a flow diagram of another embodiment of a method for rendering source content of a file for display on a destination figure.

FIG. 4 is a flow diagram of yet another embodiment of a method for rendering source content of a file for display on a destination figure

### DETAILED DESCRIPTION

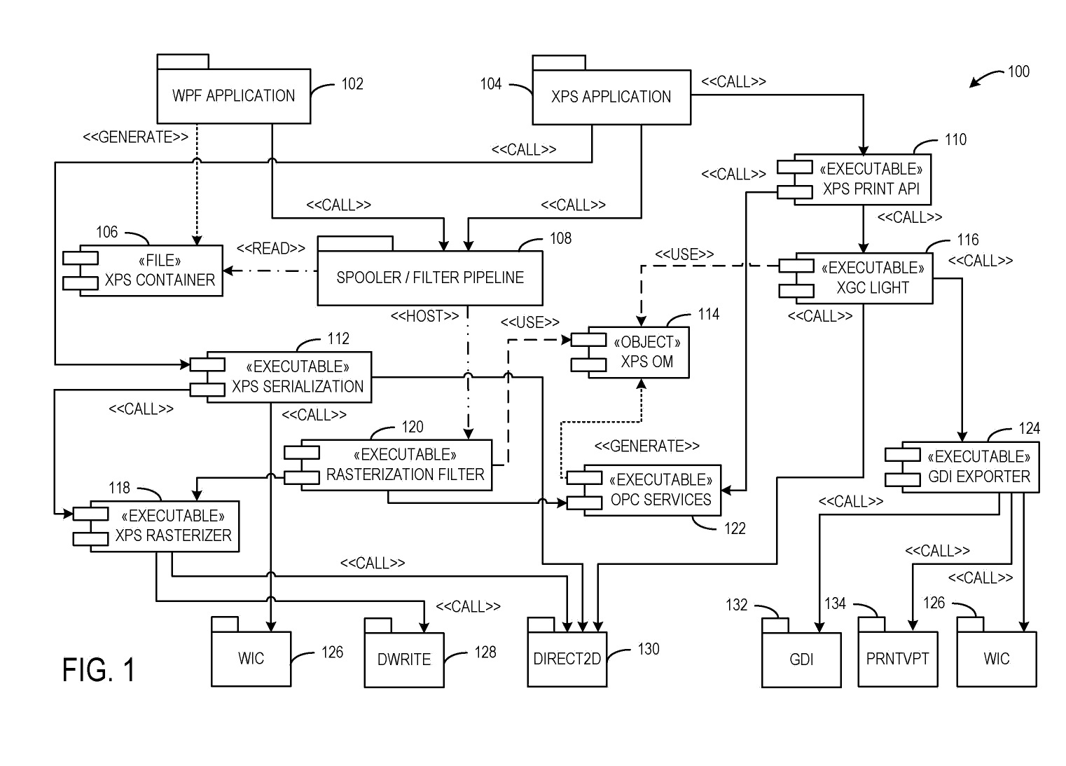

FIG. 1 illustrates a system 100 for rendering source content of a file for display, such as a fixed document file. More particularly, system 100 may operate in the context of rendering XML Paper Specification (XPS) files for display. Source content of XPS files rendered by system 100 may be displayed on a display device or printed for display on another medium, such as paper. System 100 may include a Windows Presentation Foundation (WPF) application 102. WPF application 102 may be deployed as a programming model to unify a variety of application services related to visual aspects of Windows operating system, such as fixed document rendering. WPF application may generate an XPS container 106 which may be a fixed document file containing source content. XPS application 104 may call XPS serialization module 112 to read Extensible Application Markup Language (XAML) code from WPF application 102 and create corresponding parts in the XPS document. Operation of XPS application 104 may affect rendering of source content in XPS container 106.

The print path to render the source content begins by XPS application 104 and WPF application 102 calling spooler/filter pipeline 108 to read XPS container 106 to identify source content to be rendered. XPS application 104 may call XPS print application programming interface (API) 110 to request print services to render the source content. XPS print API 110 may call Open Packaging Conventions (OPC) services 122 which may generate a XPS OM object 114 that may be used by an XPS-to-GDI Conversion (XGC) module 116 to convert the XPS formatted source content and corresponding print instructions into a Graphics Device Interface (GDI) format for rendering. XGC light module 116 may send the converted source content to DIRECT2D rendering engine 130 to be rendered for display. Further, XGC light module 116 may send the converted source content to GDI exporter 124 to package the source content for rendering by GDI rendering engine 132, Print Ticket Services (PRNTVPT) module 134, and Windows Imaging Component (WIC) 126.

Continuing with FIG. 1, spooler/filter pipeline 108 may host rasterization filter module 120 which may use XPS OM object 114 and OPC services 122 to filter or identify XPS source content to be converted into raster image instructions by XPS rasterizer module 118 for rendering by a rendering engine such as DIRECT2D rendering engine 130 or DWRITE rendering engine 128. XPS rasterizer module 118 may call XPS serialization module 112 to receive XPS formatted parts that may be utilized to rasterize the source content. Further, XPS serialization module 112 may send XPS formatted parts or instructions to WIC 126 and DIRECT2D rendering engine 130 to facilitate rendering of the XPS source content. By converting various parts and print instructions to XPS format, the format of source content of an XPS document may be unchanged throughout the printing process, and thus may retain the original quality and fidelity of the document all the way through the end of the print path. Further, the XPS print path supports a modular, filter-based architecture that allows for print rendering functions to be moved out of the application and into the print path. As such, rendering of XPS source content may be more efficiently leveraged by other applications.

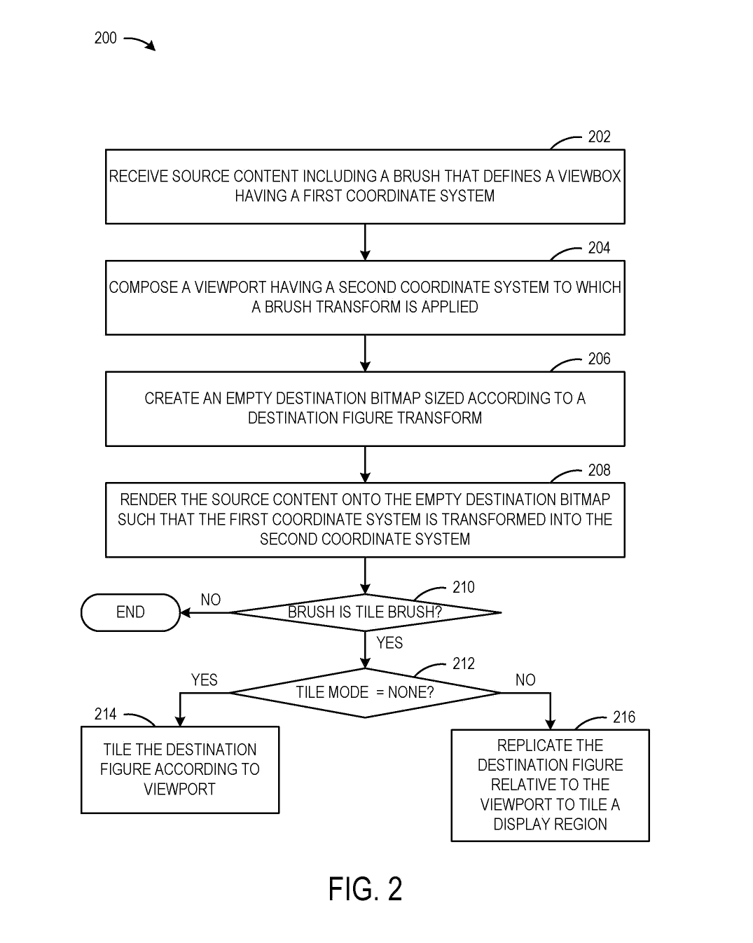

Within the context of the system 100 described above, several methods for rendering source content may be practiced, as described below with reference to FIGS. 2-4. As one example, FIG. 2 illustrates a method 200 of rendering source content of a file for display in a destination figure. Method 200 may include, at 202 receiving source content of the file including a brush that defines a viewbox having a first coordinate system. The brush may be any one of a variety of brushes used to paint interiors of paths or text of the source content. For example, the brush may be a tile brush that may be rendered once at a specified location or may be replicated to fill a display region based on a tile mode of the tile brush being off or on. In some cases, the tile brush may be a visual brush having instructions to paint visual elements such as geometry. In some cases, the tile brush may be an image brush that may paint a specified image in the display region.

At 204, the method may include composing a viewport having a second coordinate system to which a brush transform is applied. In some cases, the brush transform may change a scale of the coordinate system of the viewport. Further, in some cases, the brush transform may change an origin of the coordinate system of the viewport. Further still, in some cases, the brush transform may change both the scale and the origin of the coordinate system of the viewport.

At 206, the method may include creating an empty destination bitmap sized according to a destination figure transform. In some cases, the destination figure transform may define a scale of a coordinate system of the destination figure as well as a size and position of the destination figure within the coordinate system.

At 208, the method may include rendering the source content onto the empty destination bitmap such that the first coordinate system is transformed into the second coordinate system. At 210, the method may include determining if the brush is a tile brush. If the brush is a tile brush the method moves to 212. Otherwise the brush is determined not to be a tile brush and the method ends.

At 212, the method may include determining if a tile mode of the brush is set to “NONE.” In other words, it may be determined if a tile mode of the tile brush is turned off. If the tile mode is turned off the method moves to 214. Otherwise, the tile mode is determined to be turned on and the method moves to 216.

At 214, the method may include tiling the destination figure according to a position defined by the viewport. It will be appreciated that the destination figure is tiled only once and not replicated since the tile mode is turned off.

At 216, the method may include replicating the destination figure relative to the viewport to tile the display region. It will be appreciated that one of a variety of flipping operations may be performed when replicating the destination figure, such as flipping about the X-axis, flipping about the Y-axis, and flipping about both the X-axis and the Y-axis.

Since method 200 accounts for the size of the destination figure, a sole intermediate image having a size determined by the dimensions of the transformed viewport may be created as opposed to creating two or more intermediate images that are transformed only based on the markup of the source content without consideration of the destination figure size. Such an implementation may result in a pixellated or blurry rendered image, whereas carrying out the method result in quicker, more efficient rendering that maintains the fidelity of the source content.

It will be appreciated that method 200 may be implemented using the hardware and software of system 100 described above, or via other suitable hardware and software, to render source content of a fixed document file such as an XPS file for display. In one example, receiving the source content, composing the viewport, and creating the empty destination bitmap are performed by XPS rasterizer module 118 of system 100 and rendering the source content is performed by DIRECT2D rendering engine 130 of system 100.

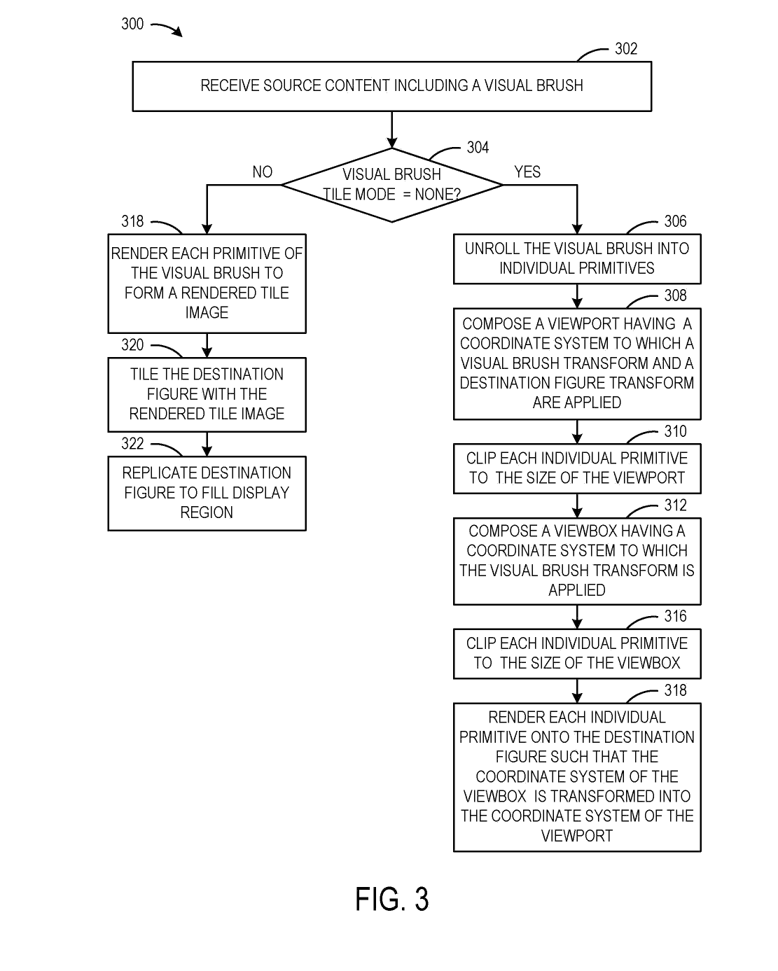

FIG. 3 illustrates a method 300 of rendering source content of a file for display in a destination figure. Method 300 may include, at 302, receiving source content including a visual brush. At 304, the method may include determining if a tile mode of the visual brush is set to “NONE” so as to not replicate the destination figure to fill a display region. In other words, it may be determined whether the tile mode is turned on or off. If it is determined that the tile mode is turned off the method moves to 306. Otherwise, the tile mode is turned on and the method moves to 318.

At 306, the method may include unrolling the visual brush into individual primitives. From this point forward in this branch of the method, each primitive may be handled independently as opposed to collectively in the visual brush.

At 308, the method may include composing a viewport having a coordinate system to which a visual brush transform and a destination figure transform are applied. In some cases, the visual brush transform and/or the destination figure transform may change a scale of the coordinate system of the viewport. Further, in some cases, the visual brush transform and/or the destination figure transform may change an origin of the coordinate system of the viewport. Further still, in some cases, the visual brush transform and/or the destination figure transform may change both the scale and the origin of the coordinate system of the viewport.

At 310, the method may include clipping the primitives to be rendered to the size of the viewport.

At 312, the method may include composing a viewbox having a coordinate system to which the visual brush transform is applied. In some cases, the visual brush transform may change a scale of the coordinate system of the viewbox. Further, in some cases, the visual brush transform may change an origin of the coordinate system of the viewbox. Further still, in some cases, the visual brush transform may change both the scale and the origin of the coordinate system of the viewbox.

At 314 the method may include clipping the primitives to be rendered to the size of the veiwbox.

At 316, the method may include rendering each individual primitive onto the destination figure such that the coordinate system of the viewbox is transformed into the coordinate system of the viewport.

Returning to 304, if the tile mode of the visual brush is turned on the method moves to 318. At 318, the method may include rendering each primitive of the visual brush to form a rendered tile image. At 320, the method may include tiling the destination figure with the rendered tile image. At 322, the method may include replicating the destination figure to fill the display region.

By unrolling the visual brush to handle the primitives individually when the destination figure does not have to be repeatedly replicated, fewer computing resources (i.e., memory, processor time) may be used, since clipping each primitive according to the viewport/viewbox may be less resource intensive than transforming and rendering the entire visual brush. Moreover, since the primitives are clipped to produce the destination figure, no intermediate image is created during rendering, which may result in quicker rendering of the source content to form the destination figure.

It will be appreciated that method 300 may be implemented using the hardware and software described above, or via other suitable hardware and software to render source content of a fixed document file such as an XPS file for display. In one example, receiving source content, unrolling the visual brush, composing the viewport, clipping primitives to be rendered to the size of the viewport, composing the viewbox, and clipping primitives to be rendered to the size of the veiwbox are performed by a XPS rasterizer module 118 of system 100 and rendering each individual primitive is performed by a rendering engine of system 100.

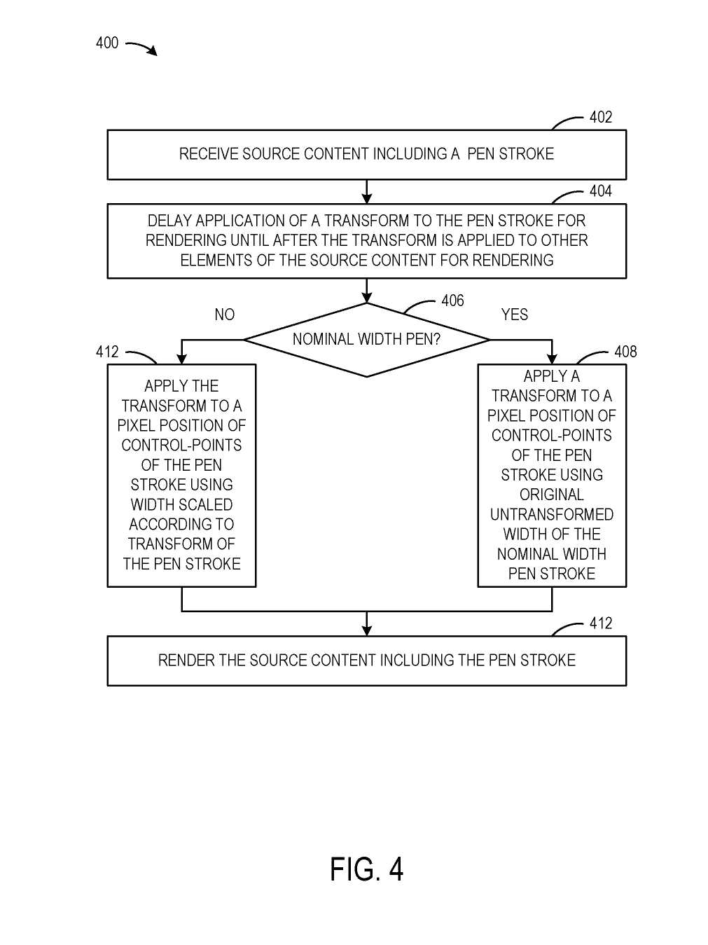

FIG. 4 illustrates a method 400 of rendering source content of a file for display in a destination figure. Method 400 may include, at 402 receiving source content including a pen stroke.

At 404, the method may include delaying application of a transform to the pen stroke for rendering until after the transform is applied to other elements of the source content for rendering.

At 406, the method may include determining if the pen stroke is a nominal width pen stroke. If the pen stroke is a nominal width pen stroke the method moves to 408. Otherwise, the pen stroke is determined not to be a nominal width pen stroke and the method moves to 410.

At 408, the method may include applying the transform to a pixel position of control-points of the pen stroke using an original untransformed width of the pen stroke. In some cases, the control-points may be vertices of a geometry created by the pen stroke.

At 410, the method may include applying the transform to a pixel position of control-points of the pen stroke using a width scaled according to the transform of the pen stroke. In some cases, the control-points may be vertices of a geometry created by the pen stroke. In some cases, the control points may be control-points of Bezier splines that make up a geometry created by the pen stroke.

At 412, the method may include rendering the source content including the pen stroke. By recognizing nominal width pens, and rendering them after other elements of the source content, all nominal width pen strokes may be drawn with a consistent width regardless of transforms in the source content. This may be particularly beneficial for consistency in generating hairlines such as in rendering figures drawn to a precise scale.

It will be appreciated that method 400 may be implemented using the hardware and software described above, or via other suitable hardware and software to render source content of a fixed document file such as an XPS file for display. It will be appreciated that two or more of the above described methods may be performed, partially or wholly, in combination to render source content for display.

It will be appreciated that the modules of system 100 which may perform at least some part of the above described methods may be executed by any suitable computing device(s). For example, the computing devices may be a mainframe computer, personal computer, laptop computer, portable data assistant (PDA), computer-enabled wireless telephone, networked computing device, printing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for rendering source content of a file for display in a destination figure comprising:
receiving the source content of the file including a brush that defines a viewbox having a first coordinate system;
composing a viewport having a second coordinate system to which a brush transform is applied;
creating an empty destination bitmap sized according to a destination figure transform; and
rendering the source content onto the empty destination bitmap such that the first coordinate system is transformed into the second coordinate system.

2. The method of claim 1, wherein the brush is a tile brush.

3. The method of claim 2, wherein the tile brush is a visual brush.

4. The method of claim 2, wherein the tile brush is an image brush.

5. The method of claim 1, wherein the brush transform changes a scale and/or an origin of the second coordinate system of the viewport.

6. The method of claim 2, further comprising:
replicating the destination figure relative to the viewport to tile a display region based on a tile mode of the tile brush being turned on.

7. The method of claim 1, wherein the file is a fixed document file.

8. The method of claim 7, wherein the fixed document file is a XML Paper Specification (XPS) file.

9. The method of claim 8, wherein receiving the source content, composing the viewport, and creating the empty destination bitmap are performed by a rasterizer module of an XPS rendering system and rendering the source content is performed by a rendering engine of the XPS rendering system.

10. The method of claim 9, wherein the rendering engine is DIRECT2D.

11. A method for rendering source content of a file for display on a destination figure comprising:
receiving source content including a visual brush;
unrolling the visual brush into individual primitives based on a tile mode of the visual brush being turned off,
composing a viewport having a coordinate system to which a visual brush transform and a destination figure transform are applied;
clipping primitives to be rendered to a size of the viewport;
composing a viewbox having a coordinate system to which the visual brush transform is applied;
clipping primitive to be rendered to a size of the veiwbox; and
rendering each individual primitive onto the destination figure such that the coordinate system of the viewbox is transformed into the coordinate system of the viewport.

12. The method of claim 11, wherein the visual brush transform changes a scale of a coordinate system of the viewport and the viewbox.

13. The method of claim 11, wherein the visual brush transform changes an origin of the coordinate system of the viewport and the viewbox.

14. The method of claim 11, wherein the file is a fixed document file.

15. The method of claim 14, wherein the fixed document file is a XML Paper Specification (XPS) file.

16. The method of claim 15, wherein receiving source content, unrolling the visual brush, composing the viewport, clipping primitives to be rendered to the size of the viewport, composing the viewbox, and clipping primitives to be rendered to the size of the veiwbox are performed by a rasterizer module of an XPS rendering system and rendering each individual primitive is performed by a rendering engine of the XPS rendering system.

17. A method for rendering source content of a file for display on a destination figure comprising:
receiving source content including a pen stroke;
delaying application of a transform to the pen stroke for rendering until after the transform is applied to other elements of the source content for rendering;
applying the transform to a pixel position of control-points of the pen stroke using an original untransformed width of the pen stroke based on the pen stroke having nominal width;
applying the transform to a pixel position of control-points of the pen stroke using a width scaled according to the transform of the pen stroke based on the pen stroke having a width greater than the nominal width; and
rendering the source content including the pen stroke.

18. The method of claim 17, wherein the control-points are vertices of a geometry created by the pen stroke.

19. The method of claim 17, wherein the control-points are control-points of Bezier splines of a geometry created by the pen stroke.

20. The method of claim 19, wherein the file is a fixed document XML Paper Specification (XPS) file.
